(19) United States
(12) Patent Application Publication
(10) Pub. No.: US 2017/0078315 A1
(43) Pub. Date: Mar. 16, 2017

(54) SYSTEMS AND METHODS FOR DETECTING VULNERABILITIES AND PRIVILEGED ACCESS USING CLUSTER OUTLIERS

(71) Applicant: BeyondTrust Software, Inc., Phoenix, AZ (US)

(72) Inventors: David Allen, Dartmouth (CA); Morey J. Haber, Altamonte Springs, FL (US); Brad Hibbert, Carp (CA)

(73) Assignee: BeyondTrust Software, Inc., Phoenix, AZ (US)

(21) Appl. No.: 14/873,108

(22) Filed: Oct. 1, 2015

Related U.S. Application Data
(60) Provisional application No. 62/217,666, filed on Sep. 11, 2015.
(60) Provisional application No. 62/234,598, filed on Sep. 29, 2015.

(51) Int. Cl. H04L 29/06

(52) U.S. Cl. CPC H04L 63/1425; H04L 63/1441

(57) ABSTRACT

Systems and methods for detecting vulnerabilities and/or privileged access are disclosed. In some embodiments, a computerized method comprises receiving asset state information and asset user behavior information for each of a plurality of assets, each of the assets connected to a network; clustering the assets into a plurality of cluster nodes based on the asset state information and the asset user behavior information, each of the assets being clustered in one of the cluster nodes, at least a first asset being clustered in a particular one of the cluster nodes; calculating a node value of the particular one of the cluster nodes, the node value based on the number of assets clustered in the particular one of the cluster nodes; comparing the node value with a threshold node value; and triggering one or more actions based on the comparison of the node value with the threshold node value.

### CROSS-REFERENCE TO RELATED APPLICATIONS

The present application claims the benefit of U.S. Provisional Patent Application Ser. No. 62/217,666, filed Sep. 11, 2015 and entitled “System and Method for Detecting Vulnerabilities Using Clustering,” and U.S. Provisional Patent Application Ser. No. 62/234,598, filed Sep. 29, 2015 and entitled “Systems and Methods for Detecting Vulnerabilities Using Clustering,” which are incorporated herein by reference.

### BACKGROUND

Technical Field

The present inventions relate generally to information security. More specifically, the present inventions relate to detecting actual and/or potential information security vulnerabilities and privileged access using cluster analysis.

Description of Related Art

Information technology and security professionals are often overloaded with privilege, vulnerability and attack information. Unfortunately, advanced persistent threats (APTs) often go undetected because traditional security analytics solutions are unable to correlate diverse data to discern hidden threats. Seemingly isolated events are often written off as exceptions, filtered out, or lost in a sea of data, and intruders continue to traverse the network and inflict increasing amounts of damage.

### SUMMARY

Some embodiments described herein include systems and methods for detecting actual and/or potential vulnerabilities associated with various assets (devices) connected to a computer network. An asset may include, for example, a personal computer, server, database, peripheral device, network device, network of devices, or other digital device. In some embodiments, a security system may collect and/or analyze information associated with the assets, including state information (e.g., port settings, service settings, user account information, set of installed applications, and so forth) and event information. Event information may include user behavior events such as logging in to an asset, launching a vulnerable application, and the like. Event information may include state changes, such as application updates, adding an application, etc. Event information may include external events, such as an attack on an asset by a hacker.

In various embodiments, the security system may evaluate the states and behaviors of each asset to generate a map, and may evaluate the cluster map to cluster similar assets together. For example, assets having similar user behavior (e.g., use particular applications, during particular times of the day, etc.) and/or states (e.g., set of applications, port settings, etc.) may be grouped together. In some embodiments, vulnerabilities and/or privileged access may be detected based on the density of the clusters. For example, low density asset clusters may indicate vulnerabilities.

In some embodiments, as state information changes, user behavior changes, external events change, etc., the security system may move one or more assets to different clusters. Based on these movements, actual and/or potential asset vulnerabilities may be detected. For example, an asset moving to a distant cluster within a short amount of time may indicate a vulnerability and/or undesirable privileged access associated with that asset.

In various embodiments, a computerized method comprises receiving asset state information and asset user behavior information for each of a plurality of assets, the security system and the plurality of assets connected to a communication network, clustering the plurality of assets into a plurality of cluster nodes based on the asset state information and the asset user behavior information, each of the plurality of assets being clustered in one of the plurality of cluster nodes, at least a first asset of the plurality of assets being clustered in a particular one of the plurality of cluster nodes, calculating a node value of the particular one of the plurality of cluster nodes, the node value based on the number of assets clustered in the particular one of the plurality of cluster nodes, comparing the node value with a threshold node value, and triggering one or more actions based on the comparison of the node value with the threshold node value.

In some embodiments, the asset state information may comprise data indicating any of (i) a set of open ports, (ii) a set of installed applications, (iii), a set of executing applications, (iv), a set of executing services, (v) a number of previously detected attacks, (vi) a set of vulnerabilities, (vii) a number of executed vulnerable applications, (viii) a risk level, or (ix) detected malware.

In some embodiments, the asset user behavior information may comprise any of one or more user calls or one or more system calls associated with any of (i) logging in to the asset, (ii) logging out of the asset, (iii) launching an application on the asset, (iv) requesting an elevated account privilege level, (v) modifying a physical configuration of the asset, or (vi) modifying a software configuration of the asset.

In some embodiments, the assets clustered within any one of the cluster nodes having at least two assets clustered therein have substantially similar asset state information and user behavior information.

In some embodiments, the node value comprises (i) the number of assets in particular one of the plurality of cluster nodes, or (ii) a percentage of the plurality of assets clustered in the particular one of the plurality of cluster nodes.

In some embodiments, the one or more actions comprise any of (i) sending an alert to an administrator of the first asset, (ii) preventing user access to the first asset, (iii) taking the first asset offline, or (iv) quarantine an application to the first asset.

In some embodiments, the method may further comprise receiving any of additional asset state information or additional asset user behavior information for at least one of the plurality of assets, and reclustering the plurality of assets into a plurality of second cluster nodes based on at least the any of the additional asset state information or additional asset user behavior information. In related embodiments, the reclustering may occur based upon one or more predetermined time intervals or newly identified events.

An example security system may comprise a communication module and an asset module. The communication module may be configured to receive asset state information and asset behavior information for each of a plurality of assets connected to a network. The asset module may be configured to (i) cluster the plurality of assets into a plurality of cluster nodes based on the asset state information and the asset user behavior information, each of the plurality of assets being clustered in one of the plurality of cluster nodes, at least a first asset of the plurality of assets being clustered in a particular one of the plurality of cluster nodes, (ii) calculate a node value of the particular one of the plurality of cluster nodes, the node value based on the number of assets clustered in the particular one of the plurality of cluster nodes, (iii) compare the node value with a threshold node value, and (iv) trigger one or more actions based on the comparison of the node value with the threshold node value.

In some embodiments, the asset state information may comprises any of (i) a set of open ports, (ii) a set of installed applications, (iii), a set of executing applications, (iv), a set of executing services, (v) a number of previously detected attacks, (vi) a set of vulnerabilities, (vii) a number of executed vulnerable applications, (viii) a risk level, or (ix) the detection of malware present.

In some embodiments, the asset user behavior information may comprise any of one or more user calls or one or more system calls associated with any of (i) logging in to the asset, (ii) logging out of the asset, (iii) launching an application on the asset, (iv) requesting an elevated account privilege level, (v) modifying a physical configuration of the asset, or (vi) modifying a software configuration of the asset.

In some embodiments, the assets clustered within any one of the cluster nodes having at least two assets clustered therein may have substantially similar asset state information and user behavior information.

In some embodiments, the node value may comprise (i) the number of assets in particular one of the plurality of cluster nodes, or (ii) a percentage of the plurality of assets clustered in the particular one of the plurality of cluster nodes.

In some embodiments, the one or more actions may comprise any of (i) sending an alert to an administrator of the first asset, (ii) preventing user access to the first asset, (iii) taking the first asset offline, or (iv) quarantine an application to the first asset.

In some embodiments, the communication module may be further configured to receive any of additional asset state information or additional asset user behavior information for at least one of the plurality of assets, and the asset module may be further configured to recluster the plurality of assets into a plurality of second cluster nodes based on at least the any of the additional asset state information or additional asset user behavior information. In related embodiments, the recluster of the plurality of assets may occur based upon one or more predetermined time intervals, or newly identified events.

In various embodiments, a non-transitory computer readable medium may comprise executable instructions, the instructions being executable by a processor to perform a method. The method may comprise receiving asset state information and asset user behavior information for each of a plurality of assets, the plurality of assets connected to a communication network, clustering the plurality of assets into a plurality of cluster nodes based on the asset state information and the asset user behavior information, each of the plurality of assets being clustered in one of the plurality of cluster nodes, at least a first asset of the plurality of assets being clustered in a particular one of the plurality of cluster nodes, calculating a node value of the particular one of the plurality of cluster nodes, the node value based on the number of assets clustered in the particular one of the plurality of cluster nodes, comparing the node value with a threshold node value; and triggering one or more actions based on the comparison of the node value with the threshold node value.

### BRIEF DESCRIPTION OF THE DRAWINGS

FIG. 1 illustrates a diagram of an environment for detecting actual and/or potential vulnerabilities associated with one or more assets according to some embodiments.

FIG. 2 is a block diagram of a security system according to some embodiments.

FIG. 3A depicts an example cluster map according to some embodiments.

FIG. 3B depicts an example updated cluster map according to some embodiments.

FIG. 4 is an example flowchart for creating an asset cluster map and detecting outlier assets according to some embodiments.

FIG. 5 is an example flowchart for creating an asset cluster map and detecting actual and/or potential asset vulnerabilities based on movement of the assets according to some embodiments.

FIG. 6 is a block diagram of a digital device according to some embodiments.

### DETAILED DESCRIPTION

Some embodiments described herein include systems and methods for detecting actual and/or potential vulnerabilities associated with various assets (e.g., devices) in a computer network. An asset may include, for example, a personal computer, server, database, peripheral device, network device, network of devices, or other digital device. In some embodiments, a security system may collect and/or analyze information associated with the assets, including state information and event information. State information may include port settings, service settings, user account information, operating system information, installed applications. Event information may include user behavior events such as log in events, application launch events, application download events, application deletion events, operating system updates, application updates, port openings, preference changes, website navigation, database access, malware, vulnerabilities, and the like. Event information may include state changes, such as application update events, application download events, application deletion events, operating system updates, etc. Event information may include external events, such as an attack event on an asset by a hacker or detected malware.

In various embodiments, the security system may evaluate the states and events associated with each asset to generate a cluster map grouping similar assets together. For example, a first set of assets having similar state information (e.g., operating system, applications loaded thereon, port settings, service settings, etc.) and having similar event information (e.g., users using particular applications during particular times of the day) may be grouped together into a first cluster. A second set of assets having similar state information and similar event information may be grouped together into a second cluster. A third set of assets having similar state information and similar event information may be grouped together into a third cluster. A fourth set of assets having similar state information and similar event information may be grouped together into a fourth cluster. The system may generate clusters in a manner such that assets of one cluster resemble the assets of its nearby clusters more closely than the assets of distant clusters. That is, the assets of the first set resemble the assets of the second set more closely than they do the assets of the third set. Similarly, the assets of the first set resemble the assets of the third set more closely than the assets of the fourth set, and so on.

In some embodiments, the system detects vulnerabilities based on cluster density. For example, an outlier (or low density grouping) may suggest an atypical state or atypical events, which may be used to infer actual or potential vulnerabilities associated with outliers.

In some embodiments, as state information and/or events (e.g., user behavior) change, the system may move one or more assets from one cluster to another in the cluster map. Based on asset movement between clusters, actual and/or potential vulnerabilities may be inferred. For example, when an asset moves to a distant cluster within a short time, the system may highlight a potential vulnerability or unapproved privileged access associated with the moving asset, such that its behavior is no longer within its norm.

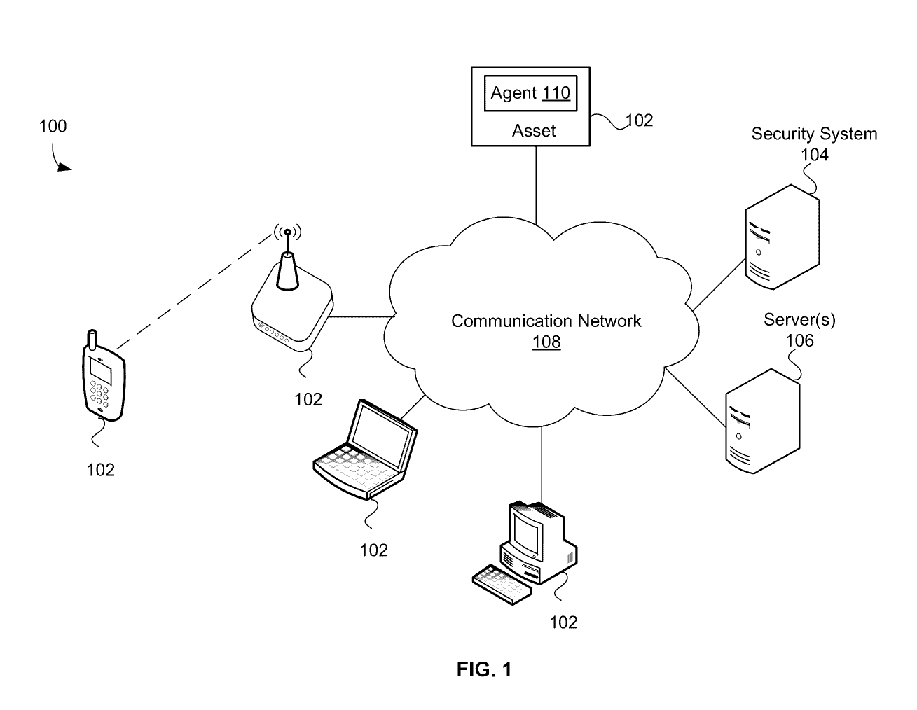

FIG. 1 illustrates a diagram of a network system 100 for detecting actual and/or potential vulnerabilities associated with one or more assets 102 according to some embodiments. In some embodiments, the network system 100 may include assets 102, a security system 104, one or more additional servers 106, and a communication network 108. In various embodiments, one or more digital devices may comprise the assets 102, the security system 104, and/or the additional servers 106. It will be appreciated that a digital device may be any device with a processor and memory, such as a computer. Digital devices are further described herein.

The assets 102 may include any physical or virtual digital device that can connect to the communication network 108. For example, an asset 102 may be a laptop, desktop, smartphone, mobile device, peripheral device (e.g., a printer), network device (e.g., a router), server, virtual machine, and so forth. It will be appreciated that, although four assets 102 are shown here, there may be any number of such assets 102.

In some embodiments, each asset 102 may execute thereon an agent 110 to facilitate the collection, storage, and/or transmission of state information and/or event information associated with the asset 102. The state information may include physical and/or software characteristics (e.g., resources) of the asset 102. In some embodiments, the state information may include the identification of open ports, service preferences, operating system, installed applications, and the like. The event information may include, for example, log-in information regarding users that log into the asset 102 (e.g., user identifications, dates, times, etc.), the applications launched on the asset 102 (e.g., identification information, version information, how used, etc.), update events (e.g., the identification of applications and/or operating system updates, date and time of updates, etc.), download events (e.g., the identification of applications, date and time of downloads, etc.), and so forth.

In some embodiments, the state information and/or event information may be collected, stored, and/or transmitted otherwise. For example, software executing on the asset 102 (e.g., malware detection software, application software, the operating system, and so forth) may perform such functionality instead of or in addition to the agent 110.

The security system 104 is configured to detect actual and/or potential vulnerabilities associated with the assets 102. In some embodiments, the security system 104 may establish baselines for normal asset 102 configurations (e.g., port settings, service settings, and the like), normal user behavior (e.g., typical login/logout times, elevated accesses, normal applications being used, normal reconfigurations, and so forth), and/or normal external events (e.g., privileged account activity). By observing changes in these configurations, behaviors, and/or external events, the security system 104 may also identify anomalies for evaluation. For example, if an accounting database (which is likely clustered with similar databases) is accessed for the first time at 2 am by a user device grouped in a cluster (e.g., engineering) that does not include accessing that database as part of its baseline activities, then the security system 104 may flag that activity as suspicious, even though that activity may not be flagged by standard protection mechanisms (e.g., malware software, firewalls, and so forth).

In various embodiments, the baselines for normal asset 102 configurations and/or normal events may be set manually (e.g., by an administrator, programmer, or the like), and/or automatically, e.g., based on historical data associated with the asset 102. For example, normal working hours associated with a particular device cluster (e.g., software development workstations) may initially be set for 9 am-5 pm. As more data is collected, the security system 104 may observe that those particular client devices are actually most often used between 10 am 7 pm, and the baseline(s) may be adjusted accordingly.

The security system 104 may be configured to isolate assets 102 exhibiting atypical behavior. For example, if a user who typically logs in to a particular asset 102 (e.g., software development workstation) between 9 am-11 am is detected logging into a payroll database (or other database the is not included in the baseline activities) at 2 am, the security system 104 may flag the activity and/or trigger an action, e.g., report the user to an administrator, prevent access to that asset 102 by the user, and so forth.

In various embodiments, the security system 104 may reevaluate the position of assets 102 in the cluster map as state and events change. For example, one or more events over a particular period of time may cause the security system 104 to cluster a particular asset 102 into a different grouping. That is, if a particular asset 102 is has state changes and user behavior changes that affect its current position in the cluster map, then the security system 104 may move the asset to the more appropriate position in the cluster map. In some embodiments, the security system 104 may detect vulnerabilities based on such movement between clusters. If the clusters in the cluster map are generated such that assets of one cluster resemble the assets of its nearby clusters more closely than the assets of distant clusters, then the security system 104 may not infer actual and/or potential vulnerability if an asset moves to a nearby cluster. However, the security system 104 may infer actual and/or potential vulnerability if an asset moves to a distant cluster. The security system 104 may look at the distance, e.g., 5 nodes away, and the rate of movement, e.g., 1 day. Similarly, the security system may look at persistence, e.g., the asset 102 is regularly moving 1 node away over the past 5 re-clustering evaluations.

In some embodiment, the security system 104 may comprise hardware, software, and/or firmware. The security system 104 may be coupled to or otherwise in communication with the communication network 108. In some embodiments, the security system 108 may comprise software configured to be run (e.g., executed) by one or more servers, routers, and/or other devices. For example, the security system 104 may comprise one or more servers, such as a windows 2012 server, Linux server, and the like. The security system 104 may be a part of or otherwise coupled to the assets 102, and/or the additional servers 106. Alternately, those skilled in the art will appreciate that there may be multiple networks and the security system 104 may communicate over all, some, or one of the multiple networks. In some embodiments, the security system 104 may comprise a software library that provides an application program interface (API). In one example, an API library resident on the security system 104 may have a small set of functions that are rapidly mastered and readily deployed in new or existing applications. There may be several API libraries, for example one library for each computer language or technology, such as, Java, .NET or C/C++ languages.

In some embodiments, the network system 100 may include one or more additional server(s) 106. The additional servers 106 may facilitate the collection, storage, and/or transmission of information associated with the assets 102. For example, the additional servers 106 may comprise a Windows server (e.g., PowerBroker for Windows Server), a UNIX/Linux server (e.g., PowerBroker for UNIX & Linux), or other solutions, such as PowerBroker Endpoint Protection Platform, Retina CS Enterprise Vulnerability Management, vulnerability scanners, and so forth. In various embodiments, the additional servers 106 may collect information from the assets 102 (e.g., state information, event information, and the like) for analysis by the security system 104.

In some embodiments, the communication network 108 represents one or more network(s). The computer network 108 may provide communication between the assets 102, the security system 104, and/or the additional servers 106. In some examples, the communication network 108 comprises digital devices, routers, cables, and/or other network topology. In other examples, the communication network 108 may be wireless and/or wireless. In some embodiments, the communication network 108 may be another type of network, such as the Internet, that may be public, private, IP-based, non-IP based, and so forth.

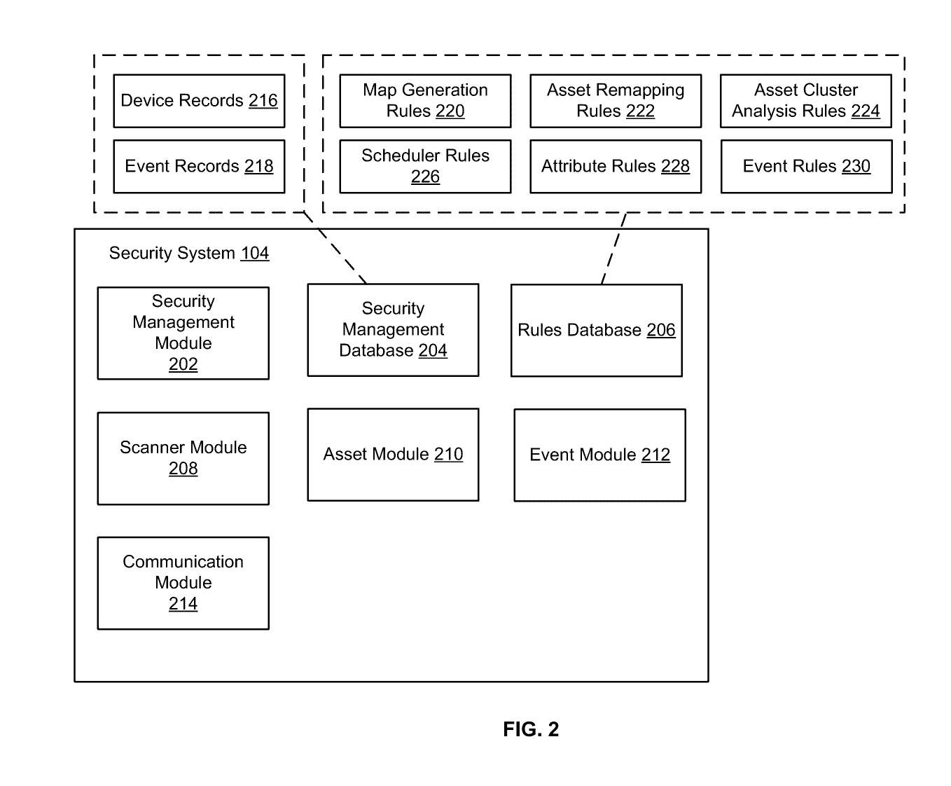

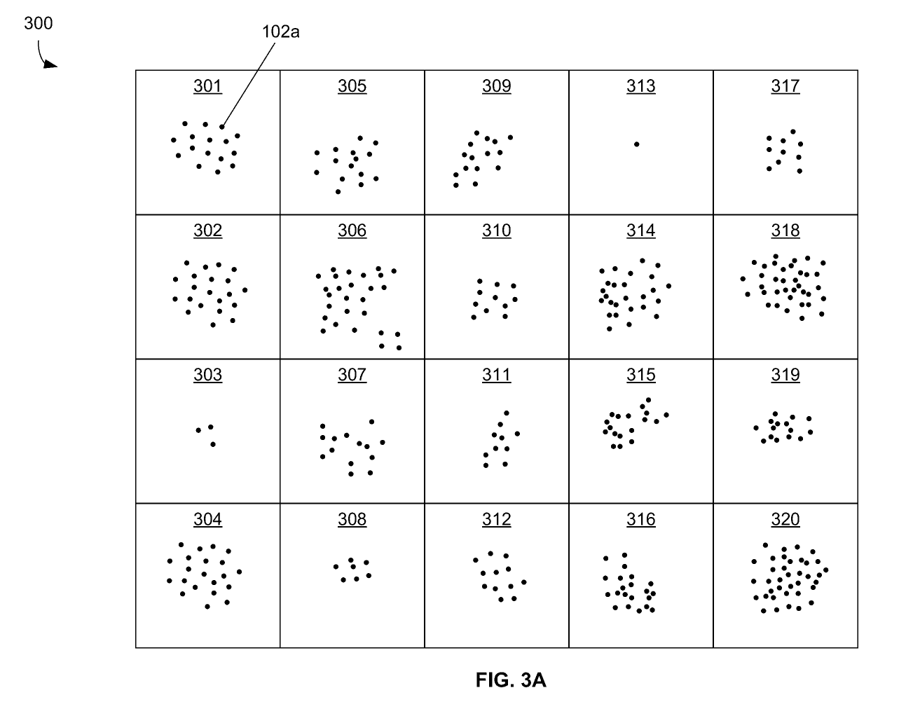

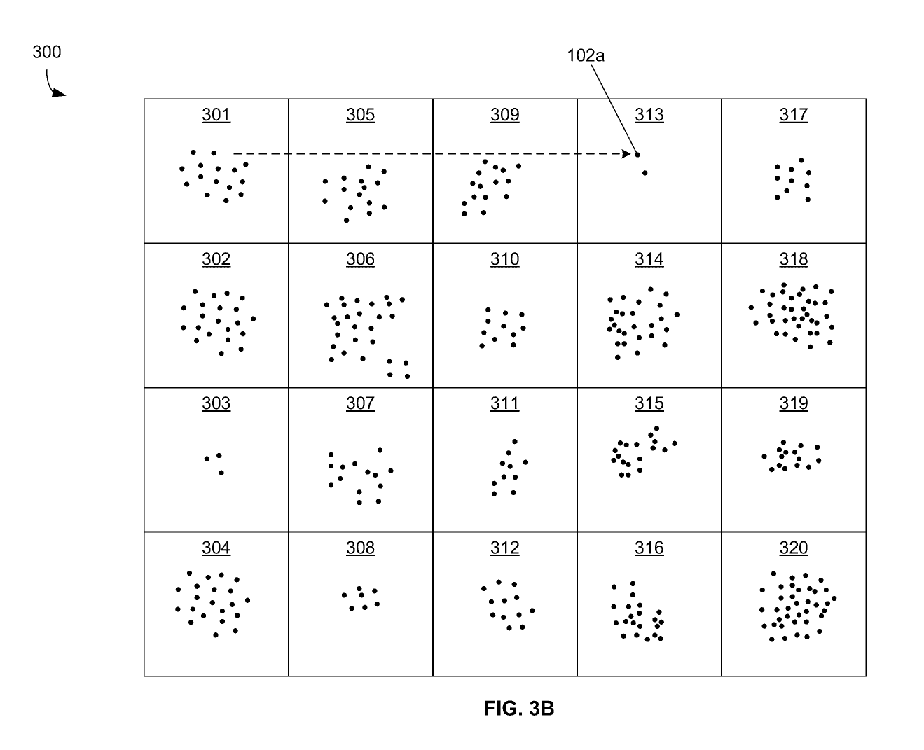

FIG. 2 is a block diagram of a security system 104 according to some embodiments. The security system 108 may include a security management module 202, a security management database 204, a rules database 206, a scanning module 208, an asset module 210, an event module 212, and a communications module 214. Generally, the security system 104 is configured to detect actual and/or potential vulnerabilities of the assets 102 using clustering of the assets 102. In some embodiments, the security system 104 collects state information and/or event information associated with the assets 102. The security system 104 may generate a cluster map (which could a database, matrix, table, tree, array, and/or other model) based on the collected state information and/or event information (e.g., see FIG. 3A). The security system 104 may update the cluster map according to a schedule, which may be based on changes in the event information and/or changes in the state information, (e.g., see FIG. 3B). In some embodiments, the security system 104 may detect actual and/or potential vulnerabilities based on density and/or movement of assets 102 between clusters, as discussed herein.

The security management module 202 is configured to create, read, update, delete, or otherwise access device records 216 and event records 218 stored in the security management database 204, and rules 220-230 stored in the rules database 206. The security management module 202 may perform any of these operations either manually (e.g., by an administrator interacting with a GUI) or automatically (e.g., by the asset module 210 or the event module 212, discussed below). In some embodiments, the management module 202 comprises a library of executable instructions which are executable by a processor for performing any of the aforementioned CRUD operations. The databases 204 and 206 may be any structure and/or structures suitable for storing the records and/or rules (e.g., active database, relational database, table, matrix, array, and the like).

The device records 216 may store a variety of current and historical state information of the assets 102. For example, each device record 216 may include a device identifier that uniquely identifies one of the assets 102, as well as various state information attributes associated with that identified client device.

In various embodiments, the state information attributes may include any of the following:
Application Vulnerability: The number of vulnerable applications launched on the client device, e.g., as detected by the security system 104 and/or additional servers 106.
Previous Attacks: The number of attacks against the client device, e.g., as detected by the security system 104 and/or additional servers 106.
Risk: The asset risk level based on data gathered by the security system 104 and/or additional servers 106.
Application Set: The set of running and/or elevated applications, e.g., as detected by the security system 104 and/or additional servers 106.
Vulnerability Set: The set of vulnerabilities, e.g., as detected by the security system 104 and/or additional servers 106.
Services Set: The set of services detected, e.g., as detected by the security system 104 and/or additional servers 106.
Software Set: The set of installed software packages, e.g., as detected by the security system 104 and/or additional servers 106.
Port Set: The set of opened ports detected, e.g., as detected by the security system 104 and/or additional servers 106.
Detected Malware: The number of applications potentially identified for containing malware.

In some embodiments, the device records 216 may additionally store historical and/or current event information associated with an asset 102. For example, user behavior may include a login time, logout time, launched applications, activities that result in a change to the client device's state information, executing applications for the first time, network activity, and so forth. In some embodiments, any of the following user behavior attributes may be stored:
User Behavior Identifier: Uniquely identifies the instance of user behavior.
Client Device Identifier: Identifies the client device associated with the user behavior.
Account Identifier: Identifies the account (e.g., a particular user or admin account) associated with the user behavior. In some embodiments, the account identifier may be hidden and/or suppressed (e.g., to comply with local data privacy laws).
User Behavior Type: A type and/or description of the user behavior. For example, behavior that modifies particular state information attributes (e.g., opening more ports), a time a user logs in and/or logs out, processes launched by a user, network activity of a user, and so forth.
Threat level: A threat level associated with the event.

In some embodiments, event information may also be stored using the event records 218, discussed below, instead of or in addition to the device records 216. For example, some or all user behaviors may be included in an event stream processed by the event module 212, discussed below.

The event records 218 may each store a variety of current and historical event information associated with one or more of the assets 102. For example, each event record 216 may include an event identifier that uniquely identifies an event, a client device identifier that identifies one of the assets 102 associated with the event, the type of event (e.g., attack event), a time of the event, a user associated with the event, and so forth. For example, the event records 218 may store values for any of the following event attributes:
Event identifier: Uniquely identifies an event.
Client Device Identifier(s): Identifies one or more client devices associated with the event.
Type: Identifies the type of event detected. For example, the event type may be an attack on the identified client device(s), a user requesting elevated privileges, a user launching an outdated application, and so forth.
Severity: A severity of the event, e.g., “low,”, “medium,” “high,” and so forth.
User Account(s): The user account(s) associated with the event.
Asset Risk: Calculated based on the asset's active vulnerabilities (e.g., the set of vulnerabilities, discussed above), combined with its potential attack surface (e.g., the state information described above).
Outlier: Indicates that a specific event is unlike other events for this user account.
First Time Application Launched: Indicates the first time a rule is triggered for this user account.
Untrusted User: Determines risk associated with the user account based on several attributes. For example, an untrusted user may be a local administrative account versus a standard user account or one managed by Active Directory.
Event Time: Indicates a time of the event and/or if the event was triggered outside of normal business hours (e.g., on a weekend). Normal business hours may be predetermined by an administrator and/or during a training phase.
Vulnerable Application: Indicates whether the related application has vulnerabilities (e.g., missing patches) on the asset from which the privilege event was triggered.
Untrusted Application: Calculates the risk of the application associated with the event.
Threat Level: Indicates a threat level for the event. For example, the threat level may be based on the asset risk attribute and the outlier attribute (e.g., a sum of those attributes).
Detected Malware: The number of applications potentially identified for containing malware.

In various embodiments, the device attribute values and/or event attribute values may be normalized values within a predetermined range (0.0-1.0), raw values, descriptive values (e.g., “low,” “medium,” “high,” and the like), binary values (e.g., 1 or 0, “on” or “off,” “yes” or “no,”) and/or the like. In some embodiments, each attribute in the records 216 and/or 218 may not include a value. In some embodiments, attributes without an assigned value may be given a NULL value and/or a default value.

The rules database 206 stores rules 220-230 for controlling a variety of functions for the security system 104, including map generation rules 220 for generating cluster maps, asset re-mapping rules 222 for reevaluating the position of an asset within the cluster, asset cluster analysis rules 224 for detecting actual and/or potential vulnerabilities of the assets 102, scheduler rules 226 for scheduling the collection and/or analysis of data associated with the assets 102, attribute rules 228 for collecting information, and event rules 230 for processing events. Other embodiments may include a greater or lesser number of such rules 220-230, stored in the rules database 206 or otherwise.

In various embodiments, some or all of the rules 220-230 may be defined manually, e.g., by an administrator, and/or automatically by the security system 104. As more information is collected and/or analyzed, the security system 104 may observe patterns based on changed state information and/or changed event information, and may update one or more of the rules 220-230 accordingly. For example, the security system 104 may observe that a particular configuration of port settings, or other device attribute(s), may be associated with an increased vulnerability risk, and update the rules accordingly. Similarly, the security system 104 may observe that a particular user behavior and/or type of external event (e.g., scan event), or combination of user behavior and external events, may be associated with an increased vulnerability risk, and update the rules accordingly.

In some embodiments, the rules 220-230 may define one or more attributes, characteristics, functions, and/or conditions that, when satisfied, trigger the security system 104, or component thereof (e.g., asset module 210 or event module 226) to perform one or more actions. For example, the database 206 may store any of the following rules:

Map Generation Rules 220

The map generation rules 220 define attributes and/or functions used for generating a cluster map. In some embodiments, the map generation rules 220 may define the number of clusters to include in the cluster map (e.g., 100 nodes), and the functions used to group assets 102 within the clusters, establish baseline attributes associated with each of the individual clusters, and/or create cluster links (e.g., a cluster hierarchy) for the cluster map.

In some embodiments, the assets 102 may be grouped based on their similarity with one or more of the other assets 102. Similarity may be based on some or all of the state information and/or event information associated with the assets 102, e.g., as stored in the device records 216 and/or event records 218. Accordingly, similar assets 102 may be grouped together within the same cluster. As noted above, a first set of assets 102 having similar state information (e.g., operating system, applications loaded thereon, port settings, service settings, etc.) and having similar event information (e.g., users typically connecting to the network between 9 am-5 pm) may be grouped together into a first cluster. A second set of assets 102 having similar state information and similar event information may be grouped together into a second cluster. A third set of assets 102 having similar state information and similar event information may be grouped together into a third cluster. A fourth set of assets 102 having similar state information and similar event information may be grouped together into a fourth cluster. In some embodiments, the map generation rules 220 may define the instructions to generate clusters in a manner such that assets 102 of a first cluster resemble the assets 102 of its nearby clusters more closely than the assets 102 of distant clusters. That is, the map generation rules 220 may define the instructions so that the assets 102 of the first set resemble the assets 102 of the second set more closely than they do the assets 102 of the third set, the assets 102 of the first set resemble the assets 102 of the third set more closely than the they do the assets 102 of the fourth set, and so on. In an organizational context, the map generation rules 220 may cause the assets 102 used by staff in the payroll department to cluster together because they have similar installed applications, running services, user behavior, and so forth, while the assets 102 used by staff in the IT department may be cluster together in a different cluster.

In various embodiments, baseline values may be established for a set of predetermined node attributes to indicate, for example, normal and/or expected state information, user behavior, and/or events for the client devices within a particular cluster. In some embodiments, the baseline node attributes may include some or all of the attributes associated with the state information and/or events discussed herein. In various embodiments, the baseline values may be calculated based on the initial clustering of the assets 102. For example, the average or typical/popular attribute values associated with the assets 102 within a particular cluster may be used (e.g., an average) to determine the baseline values associated with that particular cluster.

In some embodiments, a training phase or predetermined period may be used to establish the baseline values. The security system 104 may gather state information and/or events over a predetermined amount of time (e.g., a day, week, month, six months, etc.) to generate the cluster map and the baseline values. In some embodiments, the state information and/or event information may be gathered from logs and/or data storage, e.g., from the device records 216 and/or event records 218. If the device records 216 and/or event records 218 do not have sufficient historical information to satisfy the predetermined period, e.g., because the security system 104 was recently deployed, the security system 104 may accept the shortened period as sufficient to create the initial cluster map.

In some embodiments, the baseline values may be manually (e.g., by an administrator) and/or automatically adjusted. For example, if there are known vulnerabilities associated with one or more of the assets 102 within a particular node, the security system 104 may enable an administrator to adjust the baseline values to more accurately reflect normal and/or expected attribute values.

In various embodiments, the map generation rules 220 may define cluster links (e.g., a node hierarchy) for the clusters of the cluster map. For example, each cluster may be assigned a number (e.g., cluster 1, cluster 2, cluster 3, and so forth), and the cluster links may define a relationship (and distance) between the nodes. In some embodiments, the node links may be defined such that that a dissimilarity between the assets of any two clusters may be measured based upon a difference between cluster numbers. Thus, the dissimilarity between cluster 5 and cluster 6 may be less than the dissimilarity between cluster 10 and cluster 20. Although cluster distance is discussed herein, some embodiments may use displacement instead of or in addition to distance.

In some embodiments, the cluster map links may facilitate evaluating a state and/or behavior change within an asset 102, when an asset 102 moves between clusters, e.g., based on direction, distance, and/or time. For example, should an asset 102 move in a particular direction (e.g., up, down, left, right, diagonal, and so forth), across a particular distance (e.g., as measured by cluster number differential) over a particular amount of time (e.g., one day), security system 104 can calculate a rate of change associated with the client device and/or a velocity associated with the client device, and can estimate a vulnerability potential.

Asset Mapping Rules 222

The asset remapping rules 222 define functions and/or conditions for remapping assets 102 to a different node of a cluster map, e.g., based on a change in state information and/or event information associated with those assets 102. In some embodiments, the asset remapping rules 222 may compare some or all of the state information and/or event information with baseline values of the various nodes in the cluster map to determine a new appropriate node. In various embodiments, the asset remapping rules 222 may use the data stored in the device records 216 and/or event records 218 to perform the comparison and/or other functions of the rules 220-230.

The asset remapping rules 222 may include conditions that, when satisfied, trigger a remapping of one or more assets 102. For example, if an asset 102 deviates from one or more of the baseline values associated with that asset's current node by more than a threshold amount, the asset remapping rules 222 may trigger a remapping to find a node with baseline values more closely matching the information associated with that asset 102.

In some embodiments, some or all of the assets 102 may be assigned to the cluster map. For example, a subset of the assets 102 may be mapped based on input from a system 104 administrator. This may be helpful, for example, to determine actual and/or potential vulnerabilities of a particular type of device (e.g., personal computer, printers, mobile devices, peripheral devices, and so forth). In some embodiments, a similar objective may be achieved by assigning all of the assets 102 to the cluster map, and applying one or more filters (e.g., based on device type, device attributes, and so forth).

Asset Cluster Analysis Rules 224

The asset cluster analysis rules 224 define various functions and/or conditions that, when satisfied, may detect actual and/or potential vulnerabilities associated with one or more assets 102. In some embodiments, vulnerabilities may be detected based upon a density of assets 102 within the cluster map, and/or movement of particular assets 102 between clusters. For example, the conditions may include any of the following:
condition is satisfied if there are fewer client devices assigned to a particular node than a predetermined threshold amount. The threshold amount may be an actual number of client devices (e.g., 10), a percentage of mapped devices (e.g., 1.3%), deviation distance from other clusters, and so forth.
condition is satisfied if movement associated with an asset 120 is greater than a predetermined distance threshold value. For example, if a client device moves more than five nodes, e.g., from node 10 to node 16, then the condition is satisfied.
condition is satisfied if a rate of change associated with an asset 120 is greater than a predetermined rate of change threshold value. For example, if a device moves at a rate in excess of 5 clusters per day, (e.g., node 10 to node 16), then the condition is satisfied.
condition is satisfied if a velocity associated with the movement of an asset 120 between clusters is greater than a predetermined threshold velocity value.

In some embodiments, if a predetermined amount of assets 102 within a particular cluster (e.g., 10 client devices, 50% of the client devices, and so forth) make the same, or similar, movement (e.g., from node 3 to node 20), which may otherwise satisfy one or more of the above conditions, the condition(s) may nonetheless not be satisfied. This may help, for example, to reduce erroneous vulnerability detections.

In some embodiments, one or more actions may be triggered if one or more rule conditions are satisfied. For example, the actions may include sending an alert to an administrator, locking the associated device, taking the associated device offline, preventing associated user(s) from accessing the associated device (or other devices on the communication network 108), and so forth.

Scheduler Rules 226

The scheduler rules 226 define when and/or how often to collect information (e.g., state information, event information and so forth) from the assets 102 and/or additional servers 106, as well as when and/or how often to execute the rules 220-230. For example, the scheduler rules 226 may define that some or all information should be collected and/or analyzed once per day.

In some embodiments, the scheduler rules 224 may define when and/or how often to generate a new cluster map, e.g., by executing the map generation rules 220. This may be helpful, for example, because baseline values associated with a particular cluster map instance may become stale over time, and a new cluster map may result in more accurate baseline values. In some embodiment, the scheduler rules 226 may define that the security system 104 reevaluate the cluster map every few hours or every day. The map generation rules 220 may define that the cluster map use the last 3 months of information to generate the cluster map. And, the scheduler rules 226 may define that the assets should be reevaluated within the same cluster map on a weekly, daily, hourly, or continuous basis.

Attribute Rules 228

In some embodiments, the attribute rules 228 may define the set of attributes to include in the device records 216 and/or event records 218, discussed above, and the functions used for calculating their associated attribute values. In various embodiments, the device attribute values and/or event attribute values may be normalized values within a predetermined range (0.0-1.0), although in other embodiments, the values may be raw values, descriptive values (e.g., “low,” “medium,” “high,” and the like), and/or binary values (e.g., 1 or 0, “on” or “off,” “yes” or “no,” and so forth). It will be appreciated that every attribute in the records 216 and/or 218 may not include a value. In some embodiments, attributes without an assigned value may be given a NULL value and/or a default value.

The asset module 210 is configured to execute the rules 220-228. Thus, for example, the asset module 210, using some or all of the attribute values stored in the records 216 and/or 218, may generate a cluster map based upon the map generation rules 220, move one or more assets 102 to a different node within the cluster map based upon the asset remapping rules 222, detect actual and/or potential vulnerabilities based upon the asset cluster analysis rules 224, and/or schedule security system 104 functions based on the scheduler rules 226.

In various embodiments, the asset module 210 may process state information and/or event information associated with the assets 102. In some embodiments, the information may be received from the assets 102 and/or additional servers 106 via one or more data streams, e.g., a state information stream, an event stream, a combined stream, and so forth. The asset module 210 may parse the data stream(s) and calculate values for a predetermined set of device attributes, e.g., in accordance with the attribute rules 228. In some embodiments, the security management module 202 may then store the calculated values in the device records 216.

The event module 212 may capture a variety of different events associated with the assets 102 from the assets 102 and/or from additional servers 106. For example, the event module 212 may capture user events, state change events, scan events, privileged account events, and so forth. In some embodiments, the event module 212 may receive the events from one or more event streams. In various embodiments, the event module 212 may identify events based on event rules 230 and provide them for storage in the rules database 206.

In various embodiments, the event module 212 may parse the event stream(s) and calculate values for a predetermined set of event attributes (e.g., event ID, event type, and the like), e.g., based on the attribute rules 228. In some embodiments, the security management module 202 may then store the calculated values in the event records 218.

In some embodiments, the event module 228 may determine a threat posed by a particular event. The threat level of the event may be used to control the schedule for remapping an asset 102, for determining the rate or distance that highlights vulnerability potential, etc.

The scanner module 208 may collect data about assets 102 connected to the communication network 108. For example, the scanner module 208 may collect state information and/or event information, e.g., based on the scheduler rules 226. In some embodiments, the scanner module 208 may collect the information directly from the individual assets 102, and/or from the additional servers 106. For example, the servers 106 may collect information from the assets 102, and store the information for collection by scanner module 208 and/or analysis by the asset module 210. In various embodiments, the scanner module 208, or other feature of the security system 104, may receive the information from one or more data streams, e.g., a state information stream, an event stream, a combined data stream, and the like.

The communication module 214 is configured to provide communication between the security system 104, assets 102, and/or additional servers 106. The module 214 may also be configured to transmit and/or receive encrypted communications (e.g., VPN, HTTPS, SSL, TLS, and so forth). In some embodiments, communication may be received via one or more data streams, e.g., an event stream, state information stream, combined stream, and so forth.

FIG. 3A depicts an example cluster map 300 according to some embodiments. Although in various embodiments the cluster map 300 may be represented visually, e.g., via a GUI, it will be appreciated that the cluster map 300 shown here may be for illustrative purposes only. In some embodiments, the cluster maps described herein comprise logical groupings of assets 102 with or without any associated visual representation.

In some embodiments, the cluster map 300 may be generated by the asset module 210 based on the map generation rules 220. As shown, the cluster map 300 may include a predetermined number of cluster nodes 301-320, with individual assets 102 assigned to each nodes 301-320 based on their similarity with one or more of the other assets 102. It will be appreciated that the individual dots within the nodes 301-320 represent an asset 102 (or group of assets 102) mapped to that node. In some embodiments, each of the mapped assets 102 may be assigned to a particular node based on the data stored in the device record(s) 216 and/or event record(s) 216 associated with that asset 102.

In this example, the cluster map 300 includes asset 102a assigned to node 301. Accordingly, asset 102a may have a similar threat level, configuration, and/or user behavior as the other assets 102 assigned to node 301. As discussed above and below, in some embodiments, actual and/or potential vulnerabilities may be detected based on node density, e.g., as defined by asset cluster analysis rules 224. In various embodiments, threshold density values (e.g., actual value, percentage value, value range, and so forth) may be defined in order to determine the outlier client devices. For example, the threshold values may be defined in the asset cluster analysis rules 224. The assets 102 assigned to nodes 303 and/or 313 may be flagged as outliers, thereby indicating potential and/or actual vulnerabilities associated with those client devices. However, for example, the asset 102a may not initially be flagged for an actual or potential vulnerability since it is assigned to a relatively dense node 301.

FIG. 3B depicts an example updated cluster map 300 according to some embodiments. As shown, the asset 102a has moved from node 301 to node 313, e.g., based on the asset remapping rules 222. For example, the movement may have been based on changed state information on the asset 102, changed behavior by the asset 102a, and/or one or more events (e.g., attack events, scan events, and so forth). In some embodiments, actual and/or potential vulnerabilities may be detected based on movement of assets 102 between nodes. For example, the distance between node 301 and node 313, an amount of time elapsed during the movement, and/or a direction of the movement may be used to detect actual and/or potential vulnerabilities associated with the asset 102a. In some embodiments, the security system 104 may detect actual and/or potential vulnerabilities associated with the asset 102a if the rate of change associated with the movement, and/or the velocity associated with the movement, exceed a threshold value. For example, if the asset 102a moved from node 301 to node 313 over the course of three months, it may not be flagged, although if it moved from node 301 to node 313 in a single day, it may be flagged. Similarly, if the direction of the movement reflects decreasing risk, then the movement may not be flagged. In some embodiments, the security system 104 may detect actual and/or potential vulnerabilities based on a slow but consistent creep from one node to the next.

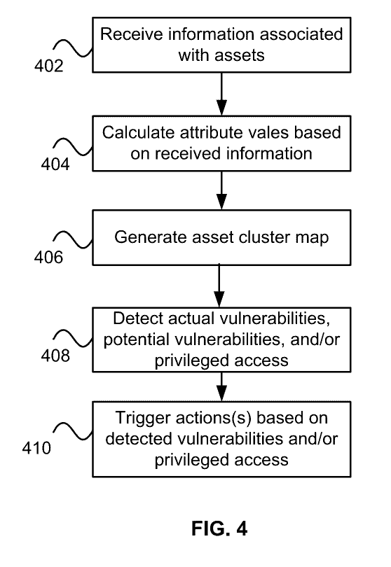

FIG. 4 is an example flowchart for creating an asset cluster map (e.g., cluster map 300) and detecting outlier assets (e.g., assets 102) according to some embodiments.

In step 402, a system (e.g., security system 104) receives historical and/or current event information associated with a plurality of assets connected to a network (e.g., network 108). In some embodiments, the information may include state information and/or event information. In various embodiments, the information may be received by a communication module (e.g., communication module 214) via one or more data streams, such as a state information data stream, event data stream, and so forth. The information may be received from the assets 102 themselves, and/or from one or more additional servers (e.g., servers 106).

In step 404, the system may calculate attribute values (e.g., device attribute values, event attribute values) based on the received information and one or more rules (e.g., event rules 230). In some embodiments, the system may store the calculated values within entries (e.g., records 216 and/or 218) of a database (e.g., database 204) or other suitable structure (e.g., table, array, and so forth).

In step 406, the system may generate an asset cluster map (e.g., cluster map 300) having a predetermined number of nodes (e.g., twenty). The system may assign the assets 102 to particular clusters based on a similarity of some or all of the attribute values between assets 102. In some embodiments, the cluster map may be created by an asset module (e.g., asset module 210) based on one or more rules (e.g., the map generation rules 220) and may include a node links, e.g., a node hierarchy. The node links may define a relationship between the nodes such that a distance may be determined between any two nodes.

In step 408, the security system 104 may detect potential and/or actual vulnerabilities associated with one or more of the assets 102 based on node density. For example, if an asset 102 is assigned to a node with fewer than a threshold amount of assets 102, the assets 102 in that particular node may be flagged as “outliers,” thereby indicating an actual and/or potential vulnerability associated with the assets 102 in that node. In some embodiments, the system may detect vulnerabilities based upon one or more rules (e.g., asset cluster analysis rules 224)

In step 410, the system may trigger one or more actions based on the detected actual and/or potential vulnerabilities and/or user behavior. For example, the security system 104 may send an alert to an administrator, lockout an associated device and/or user account, and so forth. In some embodiments, the actions may be defined and/or triggered based one or more rules (e.g., asset cluster analysis rules 224) executed by the asset module 210.

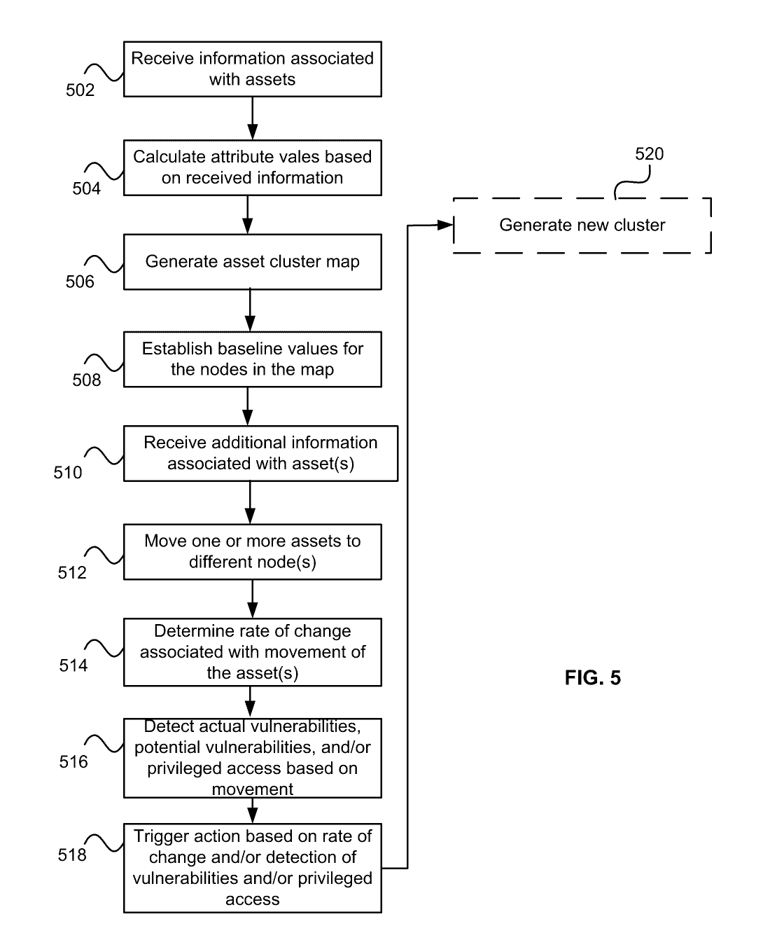

FIG. 5 is an example flowchart for creating an asset cluster map (e.g., cluster map 300) and detecting actual and/or potential asset vulnerabilities or user behavior based on movement of the assets 102 according to some embodiments.

In step 502, a system (e.g., security system 104) receives historical and/or current event information associated with a plurality of assets (e.g., assets 102) connected to a network (e.g., network 108). In some embodiments, the information may include state information and/or event information. In various embodiments, the information may be received by a communication module (e.g., communication module 214) via one or more data streams, such as a state information stream, event stream, and so forth. The information may be received from the assets 102 themselves, and/or from one or more additional servers (e.g., servers 106).

In step 504, the system may calculate attribute values (e.g., device attribute values, event attribute values) based on the received information and one or more rules (e.g., event rules 230). In some embodiments, the system may store the calculated attribute values within entries (e.g., records 216 and/or 218) of a database (e.g., database 204) or other suitable structure (e.g., table, array, and so forth).

In step 506, the system may generate an asset cluster map (e.g., cluster map 300) having a predetermined number of nodes (e.g., twenty). In some embodiments, the number of nodes may be based on the number of assets 102 to include in the cluster map. The system may assign the assets 102 to particular nodes based on a similarity of some or all of the attribute values between assets 102. In some embodiments, the asset cluster map may be created by an asset module (e.g., asset module 210) based on one or more rules (e.g., the map generation rules 220) and may include node links, e.g., a node hierarchy. The node links may define a relationship between the nodes such that a distance may be determined between any two nodes.

In step 508, the system may establish baseline attributes and values for the nodes in the cluster map. For example, baseline values for a node may be calculated based on a predetermined amount of historical information associated with the assets grouped in that node (e.g., the previous six months of information). In some embodiments, the baseline attributes are determined based on one or more rules (e.g., the map generation rules 220).

In step 510, the system may receive additional state information and/or event information associated with one or more of the assets 102. In some embodiments, the information may be received by the one or more data streams. The system, based on one or more rules (e.g., attribute rules 228), may calculate updated attribute values for the assets 102 and replace the current values with the updated values in the database. The system may additionally move the replaced values to entries in the database for historical information.

In step 512, the system may reassign one more assets 102 to different nodes based on the current and/or historical attribute values. For example, the system may compare some or all of the attribute values associated with an asset 102 (e.g., asset 102a) against the baseline values for that node (e.g., node 301), and if the difference is greater than a threshold deviation, the system may scan the cluster map for a node having baseline values that more closely match the current attribute values of the one or more assets 102. If there is such a particular node (e.g., node 313), the system may move the one or more asset 102 to that node.

In step 514, the system may determine if the change (e.g., a rate of change and/or a velocity) associated with the asset 102 that moved and compare that against one or more threshold values, e.g., based on asset cluster analysis rules 224. For example, if an asset has moved at a rate greater than a predetermined number of nodes per time period, then that may indicate actual and/or potential vulnerabilities associated with that asset or unexpected user behavior. (step 516).

In step 518, the system may trigger an action based on the detected vulnerabilities or user behavior. For example, the system may send an alert to an administrator, lock out the associate user, and so forth, based on one or more rules (e.g., asset cluster analysis rules 224).

In step 520, the system may periodically generate a new cluster map, e.g., on a daily, weekly, monthly, or yearly basis. This may help, for example, to improve the accuracy of the baseline values associated with the cluster map nodes. In some embodiments, new cluster maps may be generated based on periods defined in one or more rules (e.g., scheduler rules 224).

It will be appreciated that, although the example method steps 402-410 and 502-520 are described above in a specific order, the steps may also be performed in a different order. Each of the steps may also be performed sequentially, or serially, and/or in parallel with one or more of the other steps. Some embodiments may include a greater or lesser number of such steps.

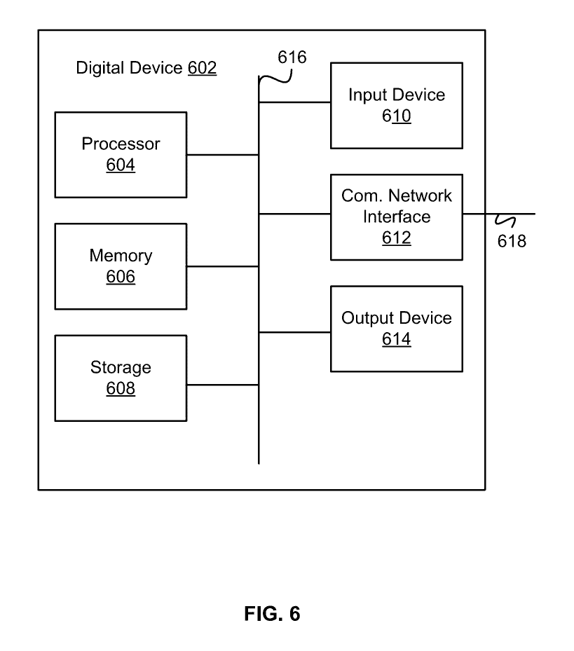

FIG. 6 is a block diagram of a digital device 602 according to some embodiments. Any of the assets 102, security system 104, and/or additional servers 106 may be an instance of the digital device 602. The digital device 602 comprises a processor 604, memory 606, storage 608, an input device 610, a communication network interface 612, and an output device 614 communicatively coupled to a communication channel 616. The processor 604 is configured to execute executable instructions (e.g., programs). In some embodiments, the processor 604 comprises circuitry or any processor capable of processing the executable instructions.

The memory 606 stores data. Some examples of memory 606 include storage devices, such as RAM, ROM, RAM cache, virtual memory, etc. In various embodiments, working data is stored within the memory 606. The data within the memory 606 may be cleared or ultimately transferred to the storage 608.

The storage 608 includes any storage configured to retrieve and store data. Some examples of the storage 608 include flash drives, hard drives, optical drives, and/or magnetic tape. Each of the memory system 606 and the storage system 608 comprises a computer-readable medium, which stores instructions or programs executable by processor 604.

The input device 610 is any device that inputs data (e.g., mouse and keyboard). The output device 614 outputs data (e.g., a speaker or display). It will be appreciated that the storage 608, input device 610, and output device 614 may be optional. For example, the routers/switchers may comprise the processor 604 and memory 606 as well as a device to receive and output data (e.g., the communication network interface 612 and/or the output device 614).

The communication network interface 612 may be coupled to a network (e.g., network 108) via the link 618. The communication network interface 612 may support communication over an Ethernet connection, a serial connection, a parallel connection, and/or an ATA connection. The communication network interface 612 may also support wireless communication (e.g., 602.11 a/b/g/n, WiMax, LTE, WiFi). It will be apparent that the communication network interface 612 can support many wired and wireless standards.

It will be appreciated that the hardware elements of the digital device 602 are not limited to those depicted in FIG. 6. A digital device 602 may comprise more or less hardware, software and/or firmware components than those depicted (e.g., drivers, operating systems, touch screens, biometric analyzers, etc.). Further, hardware elements may share functionality and still be within various embodiments described herein. In one example, encoding and/or decoding may be performed by the processor 604 and/or a co-processor located on a GPU (i.e., NVidia).

It will be appreciated that a “module,” “agent,” and/or “database” may comprise software, hardware, firmware, and/or circuitry. In one example, one or more software programs comprising instructions capable of being executable by a processor may perform one or more of the functions of the modules, databases, or agents described herein. In another example, circuitry may perform the same or similar functions. Alternative embodiments may comprise more, less, or functionally equivalent modules, agents, or databases, and still be within the scope of present embodiments. For example, as previously discussed, the functions of the various modules, agents, or databases may be combined or divided differently.

The present invention(s) are described above with reference to example embodiments. It will be apparent to those skilled in the art that various modifications may be made and other embodiments can be used without departing from the broader scope of the present invention(s). Therefore, these and other variations upon the example embodiments are intended to be covered by the present invention(s).

1. A computerized method comprising:
receiving, at a security system, state information and user behavior information for each of a plurality of assets, the security system and the plurality of assets connected to a communication network;
clustering, at the security system, the plurality of assets into a plurality of cluster nodes based on the state information and the user behavior information, each of the plurality of assets being clustered in one of the plurality of cluster nodes, at least a first asset of the plurality of assets being clustered in a particular one of the plurality of cluster nodes;
calculating, at the security system, a node value of the particular one of the plurality of cluster nodes, the node value based on the number of assets clustered in the particular one of the plurality of cluster nodes;
comparing, at the security system, the node value with a threshold node value; and
triggering, at the security system, one or more actions based on the comparison of the node value with the threshold node value.

2. The method of claim 1, wherein the state information comprises data indicating any of (i) open ports, (ii) installed applications, (iii), executing applications, (iv), executing services, (v) previously detected attacks, (vi) vulnerabilities, (vii) executed vulnerable applications, (viii) risk level, or (ix) malware.

3. The method of claim 1, wherein the user behavior information comprises any of one or more user calls or one or more system calls associated with any of (i) logging in to the asset, (ii) logging out of the asset, (iii) launching an application on the asset, (iv) requesting an elevated account privilege level, (v) modifying a physical configuration of the asset, or (vi) modifying a software configuration of the asset.

4. The method of claim 1, wherein the assets clustered within any one of the cluster nodes having at least two assets clustered therein have substantially similar state information and user behavior information.

5. The method of claim 1, wherein the node value comprises (i) the number of assets in a particular one of the plurality of cluster nodes, or (ii) a percentage of the plurality of assets clustered in the particular one of the plurality of cluster nodes.

6. The method of claim 1, wherein the one or more actions comprise any of (i) sending an alert to an administrator of the first asset, (ii) preventing user access to the first asset, or (iii) taking the first asset offline.

7. The method of claim 1, further comprising:
receiving, at the security system, any of additional state information or additional user behavior information for at least one of the plurality of assets; and
reclustering, at the security system, the at least one of the plurality of assets into a second cluster node based on at least on the additional state information or additional user behavior information.

8. The method of claim 7, wherein the reclustering occurs based on a predetermined schedule.

9. A security system comprising:
a communication module configured to receive state information and behavior information for each of a plurality of assets connected to a network; and
an asset module configured to:
cluster the plurality of assets into a plurality of cluster nodes based on the state information and the user behavior information, each of the plurality of assets being clustered in one of the plurality of cluster nodes, at least a first asset of the plurality of assets being clustered in a particular one of the plurality of cluster nodes,
calculate a node value of the particular one of the plurality of cluster nodes, the node value based on the number of assets clustered in the particular one of the plurality of cluster nodes,
compare the node value with a threshold node value, and
trigger one or more actions based on the comparison of the node value with the threshold node value.

10. The system of claim 9, wherein the state information comprises any of (i) open ports, (ii) installed applications, (iii), executing applications, (iv), executing services, (v) previously detected attacks, (vi) vulnerabilities, (vii) executed vulnerable applications, or (viii) risk level.

11. The system of claim 9, wherein the user behavior information comprises any of one or more user calls or one or more system calls associated with any of (i) logging in to the asset, (ii) logging out of the asset, (iii) launching an application on the asset, (iv) requesting an elevated account privilege level, (v) modifying a physical configuration of the asset, or (vi) modifying a software configuration of the asset.

12. The system of claim 9, wherein the assets clustered within any one of the cluster nodes having at least two assets clustered therein have substantially similar state information and user behavior information.

13. The system of claim 9, wherein the node value comprises (i) the number of assets in particular one of the plurality of cluster nodes, or (ii) a percentage of the plurality of assets clustered in the particular one of the plurality of cluster nodes.

14. The system of claim 9, wherein the one or more actions comprise any of (i) sending an alert to an administrator of the first asset, (ii) preventing user access to the first asset, or (iii) taking the first asset offline.

15. The system of claim 9, wherein:
the communication module is further configured to receive any of additional state information or additional user behavior information for at least one of the plurality of assets; and
the asset module is further configured to recluster the at least one of the plurality of assets into a second cluster node based on at least the any of the additional state information or additional user behavior information.

16. The system of claim 15, wherein the recluster of the plurality of assets occurs based upon a predetermined schedule.

17. A non-transitory computer readable medium comprising executable instructions, the instructions being executable by a processor to perform a method, the method comprising:
receiving, at a security system, state information and user behavior information for each of a plurality of assets, the security system and the plurality of assets connected to a communication network;
clustering, at the security system, the plurality of assets into a plurality of cluster nodes based on the state information and the user behavior information, each of the plurality of assets being clustered in one of the plurality of cluster nodes, at least a first asset of the plurality of assets being clustered in a particular one of the plurality of cluster nodes;
calculating, at the security system, a node value of the particular one of the plurality of cluster nodes, the node value based on the number of assets clustered in the particular one of the plurality of cluster nodes;
comparing, at the security system, the node value with a threshold node value; and
triggering, at the security system, one or more actions based on the comparison of the node value with the threshold node value.
